(19) United States
(12) Patent Application Publication
(10) Pub. No.: US 2017/0350245 A1
(43) Pub. Date: Dec. 7, 2017

(54) ANISOTROPIC PARAMETER ESTIMATION FROM WALKAWAY VSP DATA USING DIFFERENTIAL EVOLUTION

(71) Applicant: Halliburton Energy Services, Inc., Houston, TX (US)

(72) Inventors: Amit Padhi, Houston, TX (US); Mark Elliott Willis, Katy, TX (US)

(21) Appl. No.: 15/535,690

(22) PCT Filed: May 1, 2015
(86) PCT No.: PCT/US2015/028884

§ 371 Date: Jun. 13, 2017

(51) Int. Cl. E21B 49/00; E21B 41/00; G01V 1/42; G01V 1/30; E21B 44/00; E21B 47/12

(52) U.S. Cl. CPC E21B 49/00; G01V 1/306; E21B 44/00; E21B 41/0092; G01V 1/42; E21B 47/12; G01V 2210/161; G01V 2210/626

(57) ABSTRACT

In some embodiments, an apparatus and a system, as well as a method and an article, may operate to generate a parent population, wherein each member of the parent population includes a set of model parameters describing a layer model of the geological formation; to execute a perturbation algorithm to generate subsequent child populations, from the parent population, until a termination criterion is met; to provide a plurality of solutions based on at least one member of the parent population and on at least one member of each child population; and to control a drilling operation based on a revised layer model that has been generated based on a selected one of the plurality of solutions. Additional apparatus, systems, and methods are disclosed.

### BACKGROUND

Understanding the structure and properties of geological formations is important for a wide variety of applications in well and reservoir management, monitoring, and remediation. Measurement devices can make measurements in a borehole or formation (i.e., down hole measurements) to provide sonic logging data and borehole seismic data to aid in attaining this understanding. Ongoing efforts are directed to providing more efficient and accurate sonic logging.

### BRIEF DESCRIPTION OF THE DRAWINGS

FIG. 1 illustrates a seismic survey environment in accordance with some embodiments.

FIG. 2 illustrates an arrangement of geologic interfaces and seismic sources on a surface of the Earth, with receivers in the deviated borehole and connecting rays connecting sources and receivers.

FIG. 3 is a flow diagram illustrating a workflow using differential evolution and anisotropic ray tracing to extract anisotropic parameters in accordance with some embodiments.

FIG. 4 illustrates a table of shot times between five seismic sources and six seismic receivers in accordance with some embodiments.

FIG. 5 illustrates a flow diagram of a differential evolution algorithm in accordance with some embodiments.

FIG. 6 illustrates model parameters and a solution vector in accordance with some embodiments.

FIG. 7 illustrates generation of a mutant population from a parent population in accordance with some embodiments.

FIG. 8 illustrates generation of a trial population and a child population in accordance with some embodiments.

FIG. 9 is a flow diagram of an example method in accordance with various embodiments.

FIG. 10 is a block diagram of a computer system for implementing some embodiments.

FIG. 11 is a diagram of a wireline embodiment.

FIG. 12 is a diagram of a drilling rig system embodiment.

FIG. 13 illustrates best solution and true solution velocity profiles to illustrate accuracy of some embodiments.

FIG. 14 illustrates best solution and true solution epsilon profiles to illustrate accuracy of some embodiments.

FIG. 15 illustrates best solution and true solution delta profiles to illustrate accuracy of some embodiments.

FIG. 16 illustrates noisy synthetic data and data generated in accordance with some embodiments to illustrate the accuracy of some embodiments.

### DETAILED DESCRIPTION

To address some of the challenges described above, as well as others, apparatus, systems, and methods are described herein to use differential evolution to estimate anisotropic parameters of geological formations.

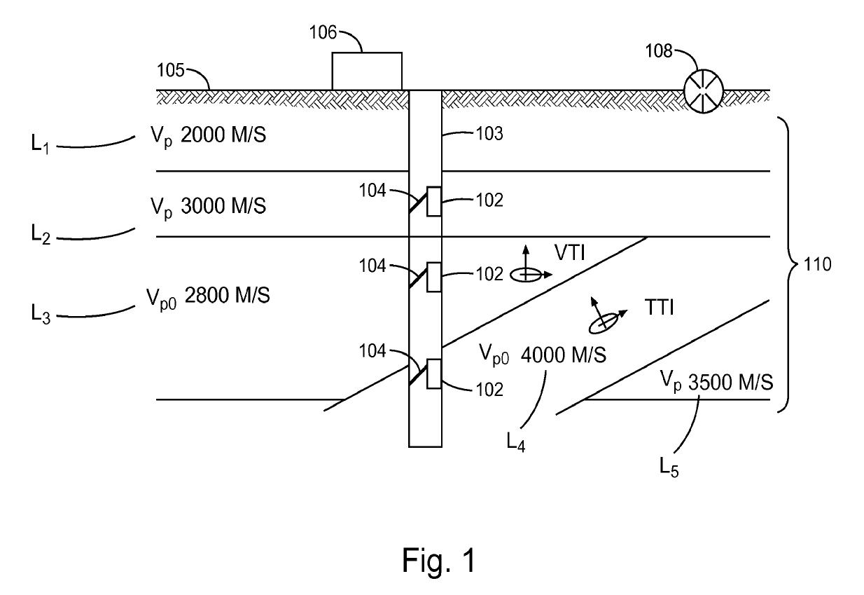

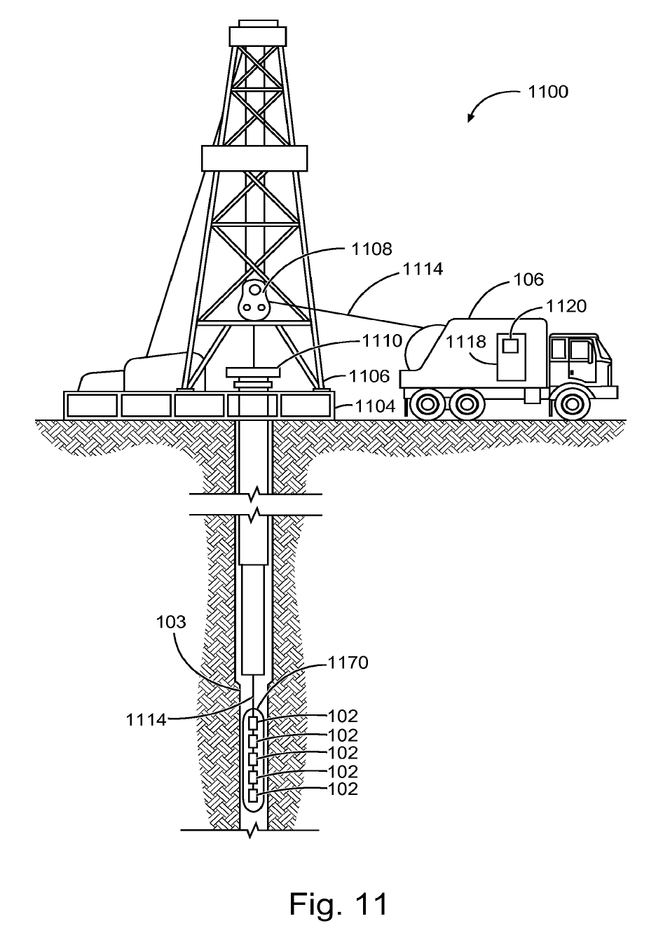

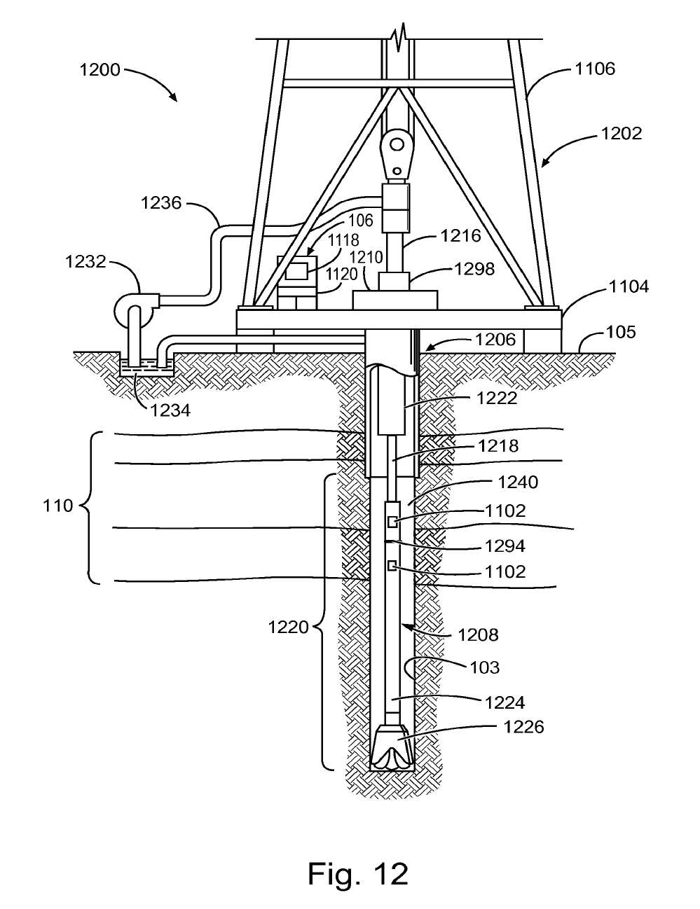

The disclosed systems and methods are best understood when described in an illustrative usage context. Accordingly, FIG. 1 shows one illustrative seismic survey environment, in which seismic receivers 102 are in a spaced-apart arrangement within a borehole 103 to detect seismic waves. As shown, the receivers 102 may be fixed in place by anchors 104 to facilitate sensing seismic waves. The environment of FIG. 1 is just one illustrative example. In different embodiments, the receivers 102 may be part of a wireline logging tool string (see FIG. 11) or a logging-while-drilling (LWD) tool (see FIG. 12) string. Further, the receivers 102 communicate wirelessly or via cable to a data acquisition unit 106 at the surface 105, where the data acquisition unit 106 receives, processes, and stores seismic signal data collected by the receivers 102.

Surveyors trigger a seismic energy source 108 (e.g., a vibrator truck) at one or more positions to emit seismic energy waves that propagate through a subsurface formation 110. Such waves refract through and reflect from acoustic impedance discontinuities to reach the receivers 102, which digitize and record the received seismic signals. The receivers 102 concurrently or in turn communicate their respective seismic signal data to the data acquisition unit 106, which stores the collected seismic signal data for later analysis to identify. Illustrative discontinuities include faults, boundaries between formation beds, and boundaries between formation fluids. The discontinuities may appear as bright spots in the subsurface structure representation that is derived from the seismic signal data.

The illustrative subsurface model of FIG. 1 includes three relatively flat formation layers L1, L2, and L3 and two dipping formation layers L4 and L5 of varying composition and hence varying speeds of seismic waves. Within any formation, the speed of seismic waves can be isotropic (i.e., the same in every direction) or anisotropic. Due to the layered structure of sedimentary rocks, transverse isotropy is common in anisotropic formations. In other words, the speed of seismic waves in anisotropic formations is the same in every horizontal direction, but is different for seismic waves traveling in the vertical direction. Note, however, that geologic activity can change formation orientations, turning a vertical transversely isotropic (VTI) formation into a tilted transversely isotropic (TTI) formation. In FIG. 1, the third flat layer L3 is VTI, while the first dipping formation layer L4 is TTI. In at least some embodiments, the disclosed anisotropy analysis technique determines anisotropy parameters for a VTI model.

The survey configuration illustrated in FIG. 1 corresponds to a vertical seismic profiling (VSP) survey configuration, where positions for surface source(s) 108 and downhole receivers 102 (e.g., as shown in example environment of FIG. 1) are used to interpret the collected seismic survey data. Systems and methods in accordance with various embodiments estimate transversely isotropic media parameters from direct P-wave arrivals in a walkaway VSP configuration similar to that shown in FIG. 1 when multiple sources 108 are used.

Operators can use the methods and apparatuses described herein to estimate average interval anisotropic parameters if the subsurface is assumed to be transversely isotropic with a vertical symmetry axis (e.g., a VTI formation as described earlier herein) or when the symmetry axis is tilted with respect to the vertical (e.g., a TTI formation). Using such estimates, operators can then generate subsurface images based on VSP data. Some available systems can generate a walkaway VSP image using a velocity model obtained from analysis of other forms of data such as surface seismic and nearby well logs. However, methods in accordance with various embodiments, which build local velocity models, may generate or allow for generation of improved or enhanced VSP images.

In available systems, and in systems according to embodiments, seismic receivers collect seismic survey data, including direct and reflected arrival data corresponding to shots from at least one source 108 at different offsets. In at least some embodiments, an inversion is performed using the collected direct and reflected arrival data simultaneously to determine anisotropy parameters, including Thomsen parameters epsilon (ε) and delta (δ), and Vₚ₀, for layers of a model having VTI layers and TTI layers. Vₚ₀₋ is the velocity of the P-wave along the symmetry axis, and ε and δ are also measured along the symmetry axis.

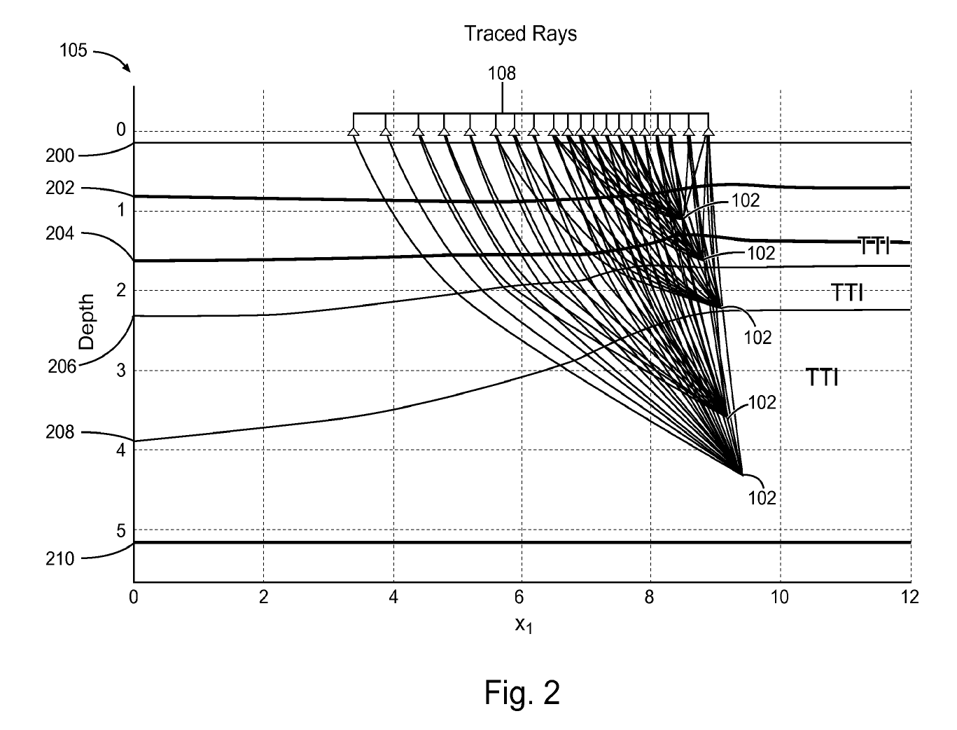

An anisotropic ray tracing (ART) algorithm can generate data similar to that illustrated in FIG. 2. FIG. 2 illustrates an arrangement of geologic interfaces 200, 202, 204, 206, 208 and 210 and seismic sources 108 on a surface 105 of the Earth, with receivers 102 in the deviated borehole and connecting rays connecting sources 108 and receivers 102. The model illustrated in FIG. 2 is assumed to have three VTI layers (e.g., the upper three layers in FIG. 2) and three TTI layers (lower three layers in FIG. 2). Methods and apparatuses in accordance with various embodiments implement an evolutionary optimization algorithm called Differential Evolution (DE), in combination with an ART algorithm, to extract anisotropic parameters (Vₚ₀, ε, δ) from P-wave first arrival travel times that can be created based on the rays received at receivers 102.

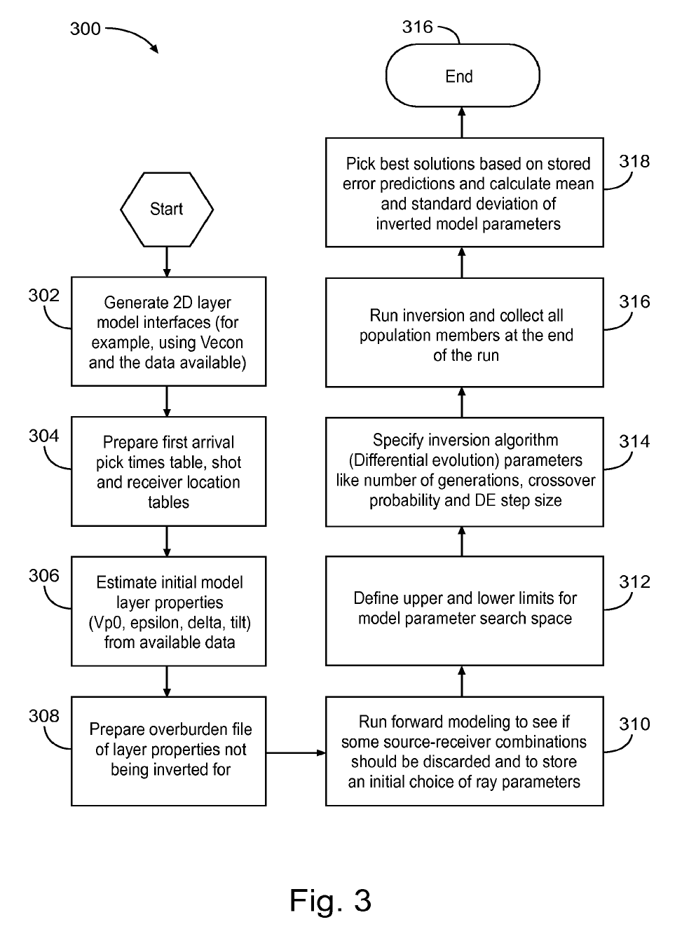

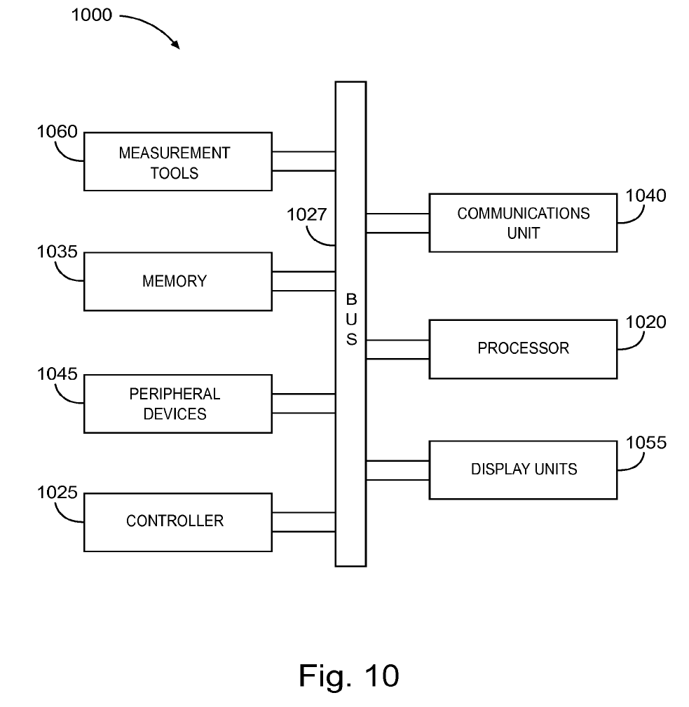

FIG. 3 is a flow diagram illustrating a workflow 300 that uses differential evolution (DE) and −DE and anisotropic ray tracing (ART) to extract anisotropic parameters in accordance with some embodiments. A processor, for example a processor within the data acquisition unit 106 or other processor (e.g., processor 1020 (FIG. 10)), can execute one or more operations in the workflow 300.

The workflow 300 begins at operation 302, with the processor 1020 (FIG. 10) generating a layered model. The layered model can be two-dimensional (2D) although embodiments are not limited to 2D models. In some embodiments, the processor 1020 can generate the layered model by deriving geological interfaces from other data, such as surface seismic depth images. In some embodiments, the processor 1020 can interpret these seismic depth images to generate the layered model. In some embodiments, the processor 1020 can generate a tomographic velocity model from inversion of surface seismic travel time data. In some embodiments, the processor 1020 may be provided with the layered model or retrieve the layered model from a storage, for example memory 1035 (FIG. 10).

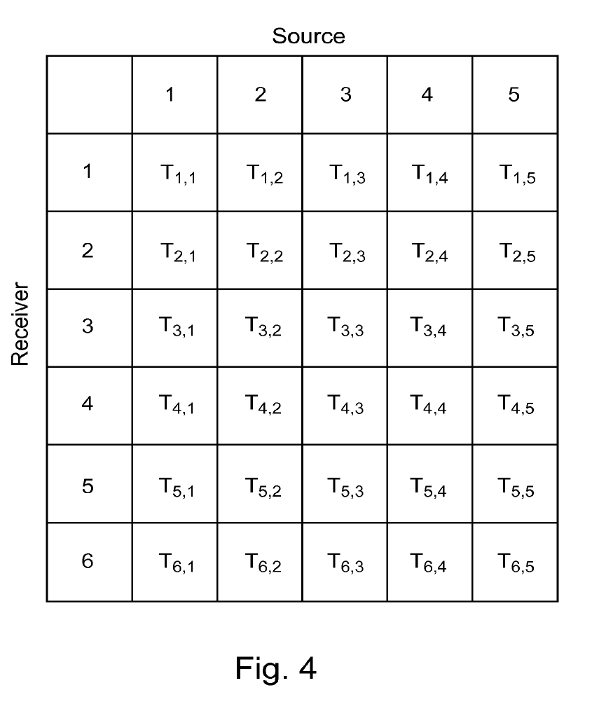

The workflow 300 continues with operation 304 when the processor 1020 prepares a table or set of tables relating source to receiver travel times. For example, a table in accordance with some embodiments can include a travel time between a number of receivers 102 and a number of seismic sources 108 (FIGS. 1 and 2). As a seismic measurement environment can have any number of receivers 102 and sources 108, any number of travel times can be captured between the receivers 102 and sources 108. An example table is shown in FIG. 4. As shown, the source to receiver travel time between a receiver and source can be expressed as T_{x,y}, where x is the receiver 102 number and y is the source 108 number.

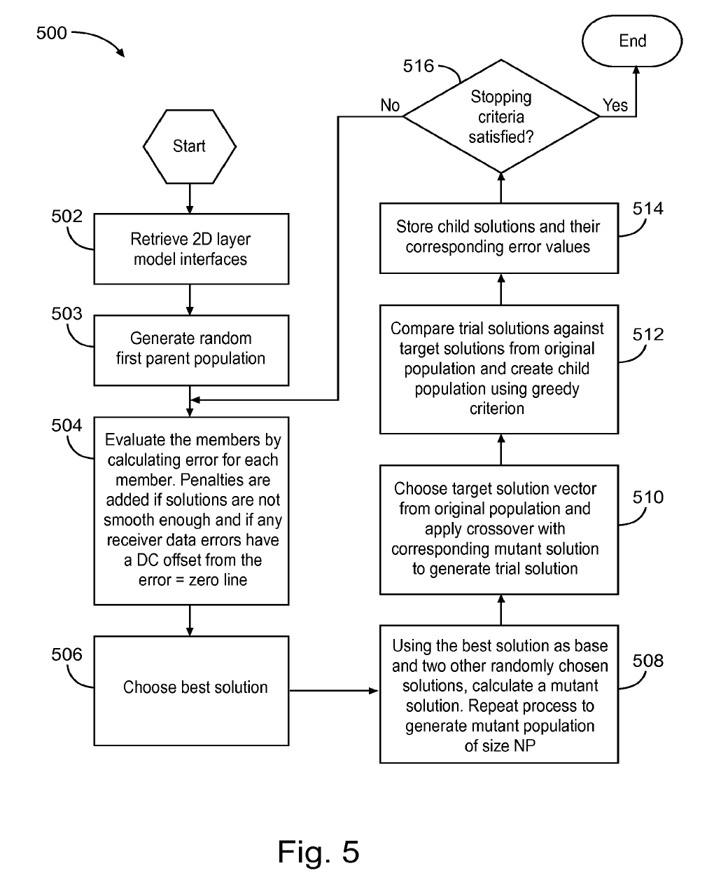

Referring again to FIG. 3, the example method continues with operation 306 with the processor 1020 estimating initial values for anisotropic parameters (Vₚ₀, ε, δ) for at least one layer (e.g., each layer) of a layer model. These initial values will be used by the DE algorithm, described in more detail later herein with reference to FIG. 5.

In some embodiments, the processor 1020 can estimate the initial values by using estimations of various model parameters from other sources of data such as, for example, surface seismic pre-stack gathers and nearby well data. These and other available estimations of model parameters may not provide sufficient accuracy for many operator use cases. Accordingly, embodiments described herein apply VSP-based anisotropic parameter extraction using available estimations and further calculations according to methods described herein.

In operation 308, the processor 1020 prepares an overburden file of layer properties that are not being inverted for. By executing operation 308, the processor 1020 can remove overburden layers from the analysis to simplify calculations to improve computation speed of further operations in accordance with various embodiments.

In operation 310, the processor 1020 runs forward modeling to determine whether some source-receiver combinations should be discarded, and to store an initial choice of ray parameters.

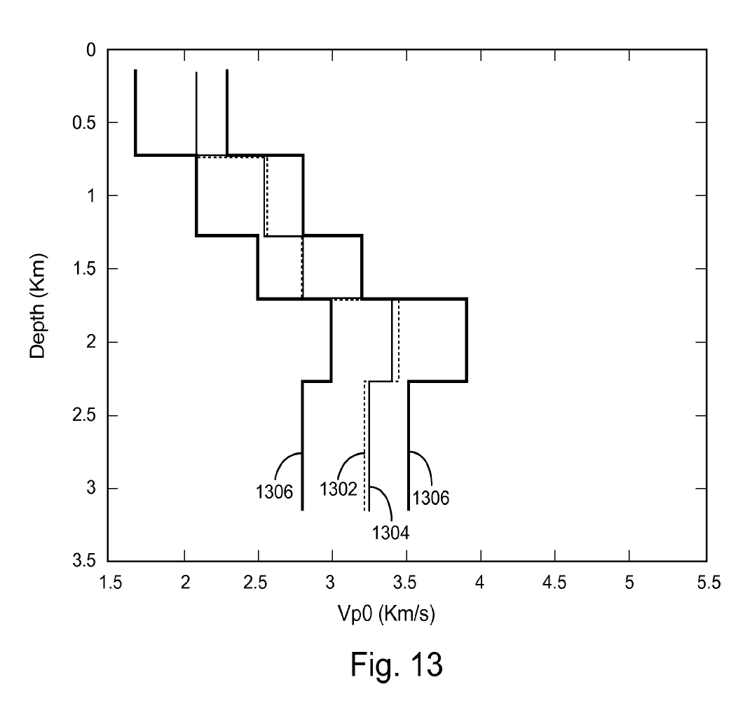

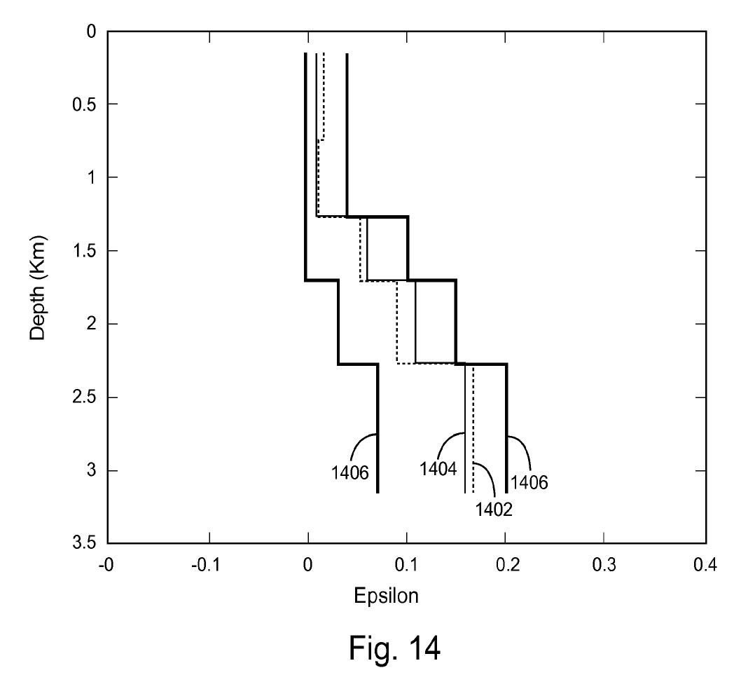

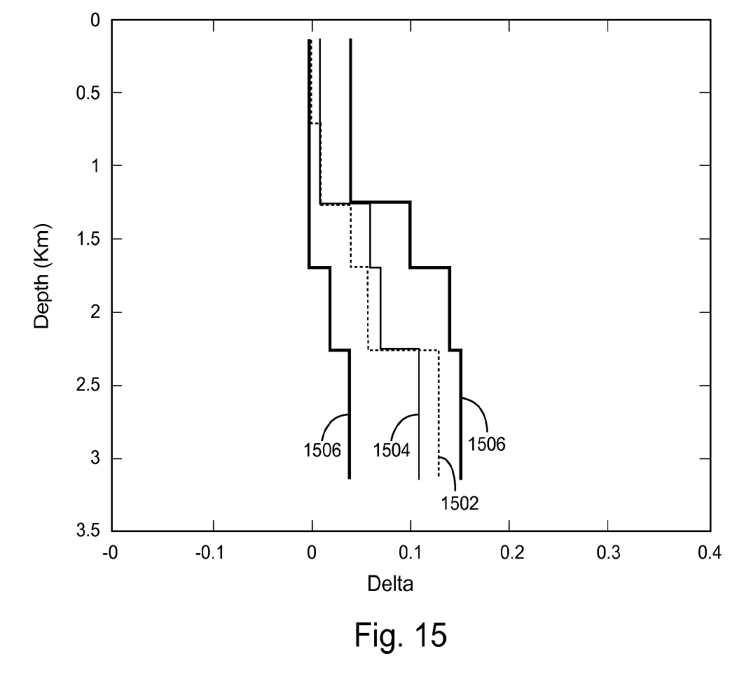

In operation 312, the processor 1020 defines upper and lower limits as model parameter search boundaries to provide a range of values for some or all of the model parameters. The upper and lower limits may be probabilistic in nature, and based on previously generated seismic data. Example model parameter search boundaries are shown in FIG. 13 (element 1306), FIG. 14 (element 1406), and FIG. 15 (element 1506). The processor 1020 will provide these search boundaries as inputs to the DE algorithm. For example, given 12 model parameters, (three model parameters for each of four layers of a model), the processor 1020 provides a lower and an upper range for each of those 12 parameters. As will be appreciated, a smaller range can lead to a correspondingly improved or faster convergence and reduced computation time, relative to large ranges for anisotropic parameter values.

In operation 314, the processor 1020 specifies inversion algorithm parameters. In embodiments, the inversion algorithm includes a global optimization algorithm. In embodiments, the inversion algorithm includes DE although embodiments are not limited thereto. The processor 1020 implements the DE algorithm (or another perturbation algorithm, genetic algorithm, or inversion algorithm) to minimize or reduce the mismatch between observed P-wave first arrival travel times and travel times that were calculated through the layered model using ART. Errors can also be introduced in observed travel times by shifts in geophone positions, or in errors due to manual processes in selecting travel times from recordings at the surface. By minimizing this difference between observed and synthetic data (using, for example, an error function or objective function), various embodiments can generate more realistic (e.g., true) layered media parameters. In embodiments, the processor 1020 can generating a revised layer model based on the minimized mismatch and the true layered media parameters.

Global optimization methods are used in various embodiments because, in the inversion of noisy data, the topography of the error function being minimized can be complicated enough for local inversion schemes to fail in reaching the global optimum. Parameters for DE can include number of generations (e.g., the number of child populations that should be generated from a parent population), crossover probability, and DE step size, although embodiments are not limited thereto. DE can provide more accurate results than available genetic algorithms at least because DE shows improved convergence properties relative to available genetic algorithms. Further, DE can be less computationally expensive than available genetic algorithms because fewer parameters are used in DE, and furthermore computational speed can be increased because DE is more easily parallelizable than other genetic algorithms.

FIG. 5 illustrates a flow diagram of a DE algorithm 500 in accordance with some embodiments. A processor such as the processor 1020 (FIG. 10) can execute one or more operations of the DE algorithm 500, to perturb model parameters and to perform recalculations, described later herein, of models and candidate solutions, until a termination criterion is met. The processor 1020 can access or retrieve results of operations of the workflow 300 (FIG. 3), for use in execution of the DE algorithm 500 of FIG. 5.

The DE algorithm 500 begins at operation 502 with the processor 1020 retrieving 2D layer model interfaces and available data related to the 2D layer model. The 2D layer model can be the same or similar as the 2D layer model generated in operation 302 (FIG. 3). Model parameters can include values for anisotropic parameters for one or more of the layers to describe properties of each layer. For example, in embodiments for which the 2D layer model includes four layers, the model parameters can include 12 values, representative of three anisotropic parameters (Vₚ₀, δ, ε) for each layer. These model parameters are perturbed by DE as described herein to minimize differences between field travel time data and synthetically produced travel time data that was generated by the previously described ART ray tracer algorithm.

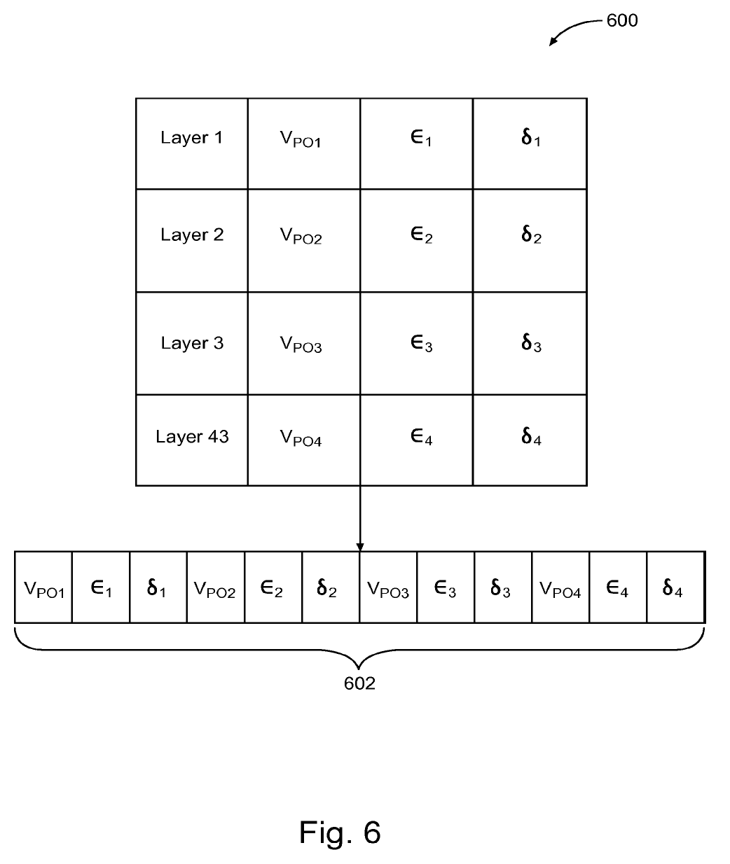

FIG. 6 illustrates an example table 600 of data on which algorithms in accordance with various embodiments may be implemented. In embodiments, the processor 1020 will determine, using DE, a solution, or a plurality of such solutions, that illustrates true effective values for anisotropic parameters at each layer of a formation of interest. A solution can be mathematically expressed as a vector 602, with 12 values, or one value for each of the parameters shown in the table 600. While values for four layers are illustrated, it will be appreciated that a model of a formation can include any number of layers, and that increased numbers (or decreased thickness) of layers can lead to increased computational time. In some examples in which properties change significantly within the physical formation, increased numbers of layers in the model can improve or enhance accuracy, although computation speed is reduced.

Referring back to FIG. 5, the DE algorithm 500 continues with operation 504 with the processor 1020 evaluating solutions, by calculating the error for respective solutions, wherein the error is based on differences between field travel time data and calculated travel times generated by ART for a given solution and layer structure. DE is an evolutionary algorithm and utilizes a population x, with population size NP of solutions, wherein a solution includes anisotropy parameters, including Thomsen ε and δ, and Vₚ₀, for layers of the 2D layer model. For example, a solution can include values similar to those shown in

FIG. 6, and a population can include several of these solutions.

The DE algorithm 500 continues with operation 506 when, for a generation G, the processor 1020 finds the solution or solutions that will be accepted and passed to the next generation. In embodiments, the processor 1020 will search for solutions with search boundaries defined for each model parameter. The definition of the search boundaries is guided by the initial guess solution obtained as described earlier.

In embodiments, the processor 1020 may impose smoothness constraints by applying a smoothing algorithm. An example smoothing algorithm can include adding a penalty term to objective function values for which a corresponding model parameter value has met or exceeded a boundary value. In some example embodiments, the penalty term will be added when two or more model parameter values have come within a threshold distance of the corresponding search boundary. As a further example, in some embodiments, the processor 1020 may add a penalty term to the objective value for a solution that produces synthetics that show a DC shift with respect to the observed field data for any receiver used in the inversion process. A DC shift in this context refers to a systematic shift in signal (travel time data) level compared to a base level, which may be defined by the level of field travel time data/signal. This latter penalty term may discourage or disfavor solutions that exhibit a good overall match with field data when all receivers are accounted for together while having mismatches when each receiver is judged separately.

In some embodiments, and as understood to be the case in general for geophysical problems, an initial guess solution may be available. Accordingly, in embodiments, the processor 1020 generates an initial guess for values for anisotropic parameters, based on available VSP data generated from other sources like surface seismic measurements and near-by wells. The processor 1020 can use an initial guess solution to generate an initial population for the DE 500 by adding random numbers to the initial guess, wherein the processor 1020 generates these random numbers based on different kinds of probability distributions. While the DE algorithm 500 can determine the globally optimal solution independent of the initial population choice, it will be appreciated that a good choice of the initial population leads to faster convergence, and therefore a faster and less computationally expensive result.

Referring back to FIG. 5, in operation 508, the processor 1020 uses the solution(s) selected in operation 506 to generate mutant solutions and trial solutions using operations analogous to mutation and crossover in available genetic algorithms. However, DE uses real number representations of individual model parameters in the solution vector, and therefore operations of DE are different from available genetic algorithms at least because available genetic algorithms use bitmap representations of parameters in the solution vector, among other differences.

The processor 1020 generates NP mutant solutions, by selecting three distinct population members with indices (r₁, r₂, r₃) for each i in (1 . . . NP), and where indices (r₁, r₂, r₃) are different from i. Using the three randomly drawn solutions (xᵣ₁, xᵣ₂, xᵣ₃) and a DE step size F (from operation 314 (FIG. 3)), a mutant solution vᵢ, is generated as:

Vᵢ=xᵣ₁+F(xᵣ₂−xᵣ₃) (1)

In embodiments, the value for F will be between 0 and 2, and the processor 1020 can vary F for any or all of the solutions vᵢ and within generations. Equation (1) is repeated NP times, to generate a mutant population of size NP.

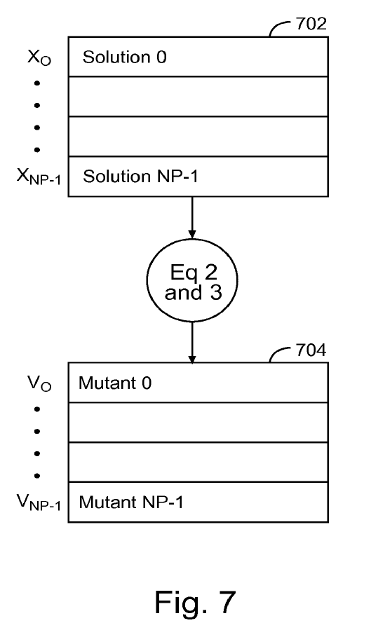

FIG. 7 illustrates generation of the mutant population in accordance with some embodiments. A parent population 702 includes NP solutions. Equation (1) uses three random solutions from the NP solutions to generate mutant population 704. However, embodiments are not limited to any particular number of random solutions.

In some embodiments, the processor 1020 can randomly perturb F according to a jitter scheme in which F is randomly perturbed for a model parameter in a mutant solution calculation in one or more of the generations. By using a jitter scheme, the processor 1020 can converge to the global optimum with smaller population sizes, which can reduce computational expense in case of inversion utilizing compute intensive forward problems such as ART.

The processor 1020 can use equation (2) to implement jitter, although embodiments are not limited to any particular scheme or jitter equation:

v_{i,j}=x_{best(i,j)}+(Fnew_{i,j})(x_{r2,j}−x_{r3,j}) (2)

where x_{best} is the best population member of the already generated population from the previous operations, wherein i is the layer number and j is the index of the parameter for layer i, and wherein Fnew is defined according to:

Fnew_{i,j}=F+0.0001* rand (3)

where rand is a random number.

Referring back to FIG. 5, in operation 510, once the processor 1020 has formed a mutant population v, the processor 1020 generates a population of trial solutions u of size NP. This process is comparable to crossover in available genetic algorithms. The processor 1020 accesses a DE crossover rate (CR) (which may be provided in operation 314 (FIG. 3)) to generate the population of trial solutions u of size NP according to:

uᵢⱼ=vᵢⱼ, if randⱼ≦CR else uᵢⱼ=xᵢⱼ (4)

where randⱼis a random number, which may have a uniform distribution between 0 and 1, generated for each model parameter in the solution, and wherein i is the layer number in the model and j is the index of the model parameter for layer l of the model.

In operation 512, subsequent to generating trial solutions u, the processor 1020 will generate a child population for the next generation. To generate the child population, the processor 1020 compares the trial population and the parent population based on their corresponding objective values. The objective values are related to the error between field data and synthetic data, which were described earlier herein, generated using a given model. In some embodiments, model parameters can be used to add penalty values to ensure smoothness of solutions. For each solution in the child population, the better solution between the solutions being compared is chosen and this process continues until all slots of the child population are filled.

The processor 1020 generates each subsequent child population by selecting population members, based on objective function values, from a sequentially previous child population (or, e.g., the initial parent population if the child population being generated is the first child population) and a trial population. In some embodiments, to speed the computation time, objective functions can be evaluated in parallel, because such evaluation is independent for each solution and therefore the computation is embarrassingly parallel. While other computations, for example computations related to Equations (1) and (4) may be performed in parallel, these other computations may not affect the computation speed to the extent that objective function evaluation or ART parallelization might.

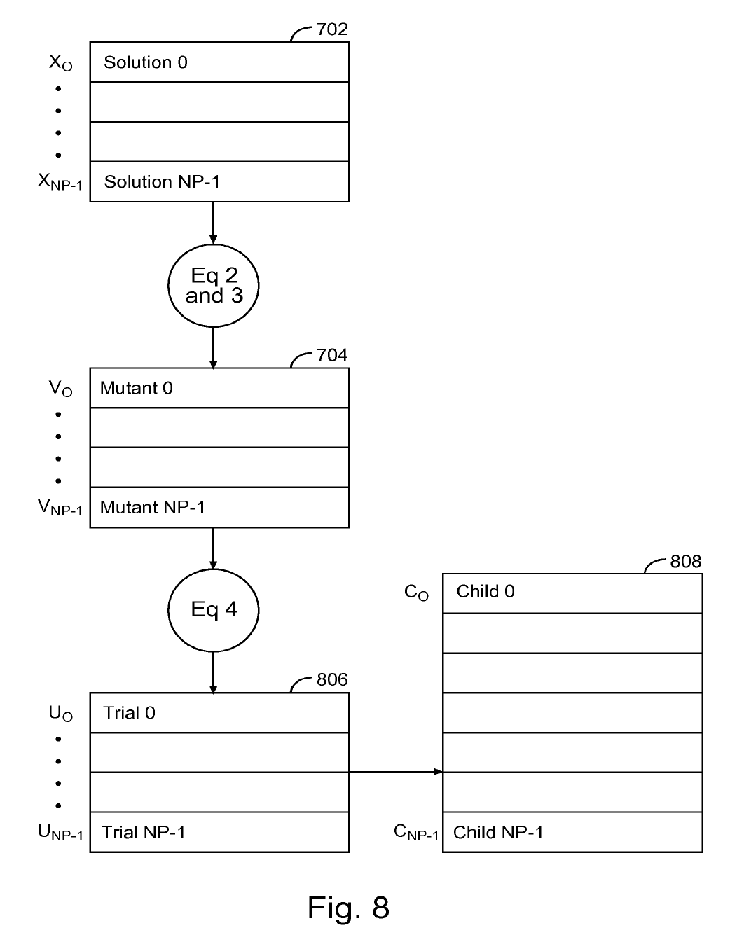

FIG. 8 illustrates generation of a child population 808 in accordance with some embodiments. A parent population 702 includes NP solutions. The processor 1020 uses Equations (2) and (3) and three random solutions from the NP solutions to generate mutant population 704. The processor 1020 uses Equation (4) to generate a trial population 806. Next, the processor 1020 compares objective functions for each solution of the parent population 702 to the objective function for each solution of the trial population 806, to generate the child population 808. Accordingly, for each member (C₀ . . . C_{NP-1}) in the child population 808, the processor 1020 compares objective function values for the parent population 702 and the trial population 806, and a solution of either the parent population 702 or the trial population 806 will become a member in the new child population 808. Therefore, the child population 808 can include diverse members or solutions from two other populations, rather than just including a mutation of one of the parent population 702 or trial population 806.

Referring again to FIG. 5, in operation 514, the processor 1020 may store data representative of the child population at the end of every generation in a physical memory, for example memory 1035 (FIG. 10). This process is repeated until some predefined termination criterion/criteria is satisfied in operation 516. Such criteria may include or be based on the number of generations or a predefined objective function value cutoff or both.

Criteria are not limited to these criteria, however, and some embodiments can use other termination criteria.

Accordingly, the DE 500 of FIG. 5 generates a collection of all population members over multiple generations and, referring again to FIG. 3, in operation 316, the processor 1020 collects these population members, wherein a population member includes a solution comprised of values for the anisotropic parameters of layers of the 2D layer model from operation 302.

In operation 318, the processor 1020 picks the best solutions based on stored error predictions and calculates mean and standard deviation of inverted model parameters. In embodiments, the processor 1020 may present one or several solutions to a display and receive an input selection of one of the solutions. In embodiments, the processor 1020 may store all population members, generations, and objective function values, and present these for display, e.g., by plotting, such that the display shows clusters of values for model parameters. Solutions can be selected based on objective value tables, or a solution can be generated based on a mean or standard deviation among some or all of the population members, by way of nonlimiting example.

Algorithms in accordance with various embodiments may be executed in a windowed fashion such that a portion of the model is inverted at a time while keeping a fixed overburden. Two or more layers of the model may be solved together to reduce computation complexity, and to allow the processor 1020 to learn of any issues in solving the model before moving on to further layers of the model.

While some available systems may invert for a single layer each time using a layer stripping approach, the inventors have discovered that inverting for a few layers together reduces the uncertainty in anisotropic parameter estimation. Additionally, inverting for a few layers together can increase the chance that the processor 1020 will obtain a global solution, because values of anisotropic parameters that may seem reasonable for a single layer may have deleterious effects on the travel time modeling of layers underneath that single layer. For example, solutions that might seem correct under a single-layer approach as used in available systems will be rejected when the processor 1020 implements methods according to various embodiments if those solutions create larger errors with receivers in other layers.

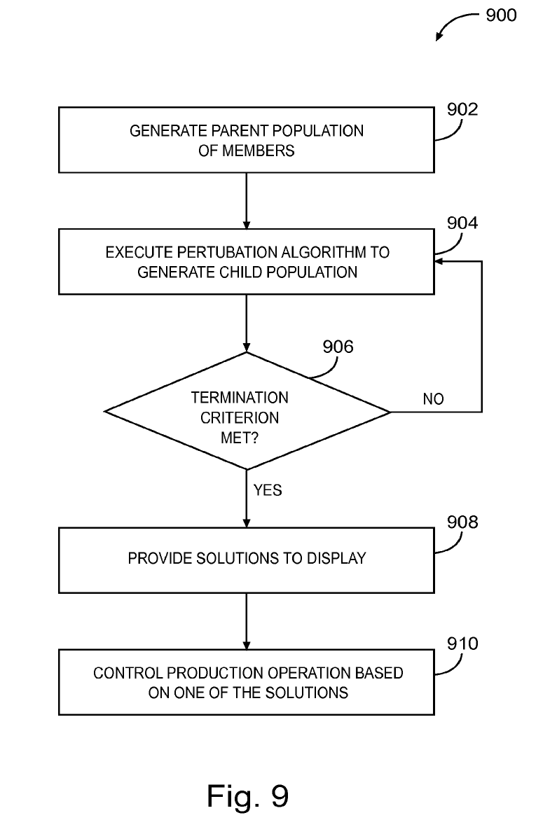

FIG. 9 is a flowchart of an example method 900 for estimating parameters of a geological formation in accordance with various embodiments. Some operations of the example method 900 can be implemented by a processor 1020.

Example method 900 begins with operation 902 with the processor 1020 generating a parent population 702 (FIGS. 7 and 8). Each member of the parent population 702 includes a set of model parameters (e.g., a solution) describing a layer model of the geological formation. The parent population can include solutions generated according to operation 306 (FIG. 3), although embodiments are not limited thereto. The model parameters include a propagation velocity Vₚ₀ of acoustic waves along a symmetry axis within each respective layer of the geological formation, and anisotropic parameters ε and δ along the symmetry axis of each respective layer of the geological formation.

Example method 900 continues with operation 904 with the processor 1020 executing a perturbation algorithm to generate subsequent child populations 808 (FIG. 8), from the parent population 702, until a termination criterion is met in operation 906. As described earlier herein, the perturbation algorithm may include a differential evolution (DE) algorithm.

Child populations can be generated as described earlier herein with reference to FIG. 5. For example, and as described in more detail earlier herein, generating child populations 808 can include generating mutant populations 704 (FIG. 7, and Equation (1)) and trial populations 806 (FIG. 8, Equation (4)). The method 900 can include providing a step size, similarly to operation 314 (FIG. 3), for generating a DE mutant solution, similarly to operation 508 (FIG. 5) for each child population 808 member generated by the DE algorithm. The method 900 can further include perturbing the step size for each model parameter in each mutant solution calculation in each subsequent child population. The processor 1020 can generate each subsequent child population by selecting population members, based on objective function values, from a sequentially previous child population 808 and a mutant population 704. The termination criterion can include, by way of nonlimiting example, at least one of a value for the number of child populations that have been generated and a threshold value corresponding to the objective function. The objective function values can be determined based on a crossover rate.

Example method 900 continues with operation 908 with the processor 1020 providing a plurality of solutions, based on at least one member of the parent population 702 and on at least one member of each child population 808, for display.

Example method 900 continues with operation 910 with the processor 1020 controlling a drilling operation based on a revised layer model that has been generated based on a selected solution of the plurality of solutions. The selected solution can be generated by the processor 1020 in a manner similar to that described above with respect to operation 318 (FIG. 3).

FIG. 10 depicts a block diagram of features of a system 1000 in accordance with various embodiments. The system 1000 can provide a recommendation for improved or optimized paths through a data acquisition unit 106 refinement of measurement data related to measured parameters as described above. Additionally, the system 1000 can provide any other functionality described above with reference to FIGS. 1-9.

The system includes a processor 1020. The system 1000 can additionally include a controller 1025 and a memory 1035. The measurement tools 1060 can include downhole measurement tools, logging tools, etc. The memory 1035 can store measurement data, P-wave first arrival times, objective function values and solutions for an initial parent population, child populations, trial populations, mutant populations, or any other data related to anisotropic parameters and other parameters as described earlier herein. The processor 1020 can access the measurement data to perform any of the operations described herein.

The communications unit 1040 can provide surface communications with wellheads, geophones, measurement tools, etc., in measurement and control operations. Such surface communications can include wired and wireless systems. Additionally, the communications unit 1040 can provide downhole communications in a measurement operation, although such downhole communications can also be provided by any other system located at or near measurement coordinates of a surface of the Earth where measurement will take place. Such downhole communications can include a telemetry system.

The system 1000 can also include a bus 1027, where the bus 1027 provides electrical conductivity among the components of the system 1000. The bus 1027 can include an address bus, a data bus, and a control bus, each independently configured. The bus 1027 can also use common conductive lines for providing one or more of address, data, or control, and the controller 1025 can regulate usage of these lines. The bus 1027 can include instrumentality for a communication network. The bus 1027 can be configured such that the components of the system 1000 are distributed. Such distribution can be arranged between surface components, downhole components and components that can be disposed on the surface of a well. Alternatively, various ones of these components can be co-located, such as on one or more collars of a drill string or on a wireline structure.

In various embodiments, the system 1000 comprises peripheral devices 1045 that can include displays, user input devices, additional storage memory, and control devices that may operate in conjunction with the controller 1025 or the memory 1035. For example, the peripheral devices 1045 can include a user input device to receive user input responsive to providing a plurality of solutions as described earlier herein, and GUI screens for displaying, for example, plots of the plurality of solutions, layer models, etc.

In an embodiment, the controller 1025 can be realized as one or more processors. The peripheral devices 1045 can be programmed to operate in conjunction with display unit(s) 1055 with instructions stored in the memory 1035 to implement a GUI to manage the operation of components distributed within the system 1000. A GUI can operate in conjunction with the communications unit 1040 and the bus 1027.

In various embodiments, a non-transitory machine-readable storage device can comprise instructions stored thereon, which, when performed by a machine, cause the machine to perform operations, the operations comprising one or more features similar to or identical to features of methods and techniques described herein. A machine-readable storage device, herein, is a physical device that stores data represented by physical structure within the device. Examples of machine-readable storage devices can include, but are not limited to, memory 1035 in the form of read only memory (ROM), random access memory (RAM), a magnetic disk storage device, an optical storage device, a flash memory, and other electronic, magnetic, or optical memory devices, including combinations thereof.

One or more processors such as, for example, the processor 1020, can operate on the physical structure of such instructions. Executing these instructions determined by the physical structures can cause the machine to perform operations to generate a parent population, wherein each member of the parent population includes a set of model parameters describing a layer model of the geological formation; to execute a perturbation algorithm to generate subsequent child populations, from the parent population, until a termination criterion is met; to provide a plurality of solutions based on at least one member of the parent population and on at least one member of each child population; and to control a drilling operation based on a revised layer model that has been generated based on a selected solution of the plurality of solutions.

The instructions can include instructions to cause the processor 1020 to perform any of, or a portion of, the above-described operations in parallel with performance of any other portion of the above-described operations. The processor 1020 can store, in memory 1035, any or all of the data received from the measurement tools 1060.

As described earlier herein, receivers 102 and other seismic equipment can be used in a logging-while-drilling (LWD) assembly or a wireline logging tool. FIG. 11 illustrates a wireline system 1100 embodiment of the invention, and FIG. 12 illustrates a drilling rig system 1200 embodiment of the invention. Thus, the systems 1100, 1200 may comprise portions of a wireline logging tool body 1170 as part of a wireline logging operation, or of a downhole tool 1224 as part of a downhole drilling operation. Thus, FIG. 11 shows a well during wireline logging operations. In this case, a drilling platform 1104 is equipped with a derrick 1106 that supports a hoist 1108.

Drilling oil and gas wells is commonly carried out using a string of drill pipes connected together so as to form a drilling string that is lowered through a rotary table 1110 into a wellbore or borehole 103. Here it is assumed that the drilling string has been temporarily removed from the borehole 103 to allow a wireline logging tool body 1170, such as a probe or sonde, to be lowered by wireline or logging cable 1114 into the borehole 103. Typically, the wireline logging tool body 1170 is lowered to the bottom of the region of interest and subsequently pulled upward at a substantially constant speed.

During the upward trip, at a series of depths the instruments (e.g., the receivers 102) included in the tool body 1170 may be used to perform measurements on the subsurface geological formations adjacent the borehole 103 (and the tool body 1170). The measurement data can be communicated to a data acquisition unit 106. The data acquisition unit 106 may be provided with electronic equipment for various types of signal processing. Similar formation evaluation data may be gathered and analyzed during drilling operations (e.g., during LWD operations, and by extension, sampling while drilling).

In some embodiments, the tool body 1170 comprises receivers 102 for detecting seismic sources, generated as described earlier herein with respect to FIG. 1, in a subterranean formation through a borehole 103. The tool is suspended in the wellbore by a wireline cable 1114 that connects the tool to a surface control unit (e.g., comprising a workstation 1118, which can also include a display). The tool may be deployed in the borehole 103 on coiled tubing, jointed drill pipe, hard-wired drill pipe, or any other suitable deployment technique.

Turning now to FIG. 12, it can be seen how a system 1200 may also form a portion of a drilling rig 1202 located at the surface 105 of a well 1206. The drilling rig 1202 may provide support for a drill string 1208. The drill string 1208 may operate to penetrate the rotary table 1110 for drilling the borehole 103 through the subsurface formations 110. The drill string 1208 may include a Kelly 1216, drill pipe 1218, and a bottom hole assembly 1220, perhaps located at the lower portion of the drill pipe 1218.

The bottom hole assembly 1220 may include drill collars 1222, a downhole tool 1224, and a drill bit 1226. The drill bit 1226 may operate to create the borehole 103 by penetrating the surface 105 and the subsurface formations 110. The downhole tool 1224 may comprise any of a number of different types of tools including MWD tools, LWD tools, and others.

During drilling operations, the drill string 1208 (perhaps including the Kelly 1216, the drill pipe 1218, and the bottom hole assembly 1220) may be rotated by the rotary table 1210. Although not shown, in addition to, or alternatively, the bottom hole assembly 1220 may also be rotated by a motor (e.g., a mud motor) that is located downhole. The drill collars 1222 may be used to add weight to the drill bit 1226. The drill collars 1222 may also operate to stiffen the bottom hole assembly 1220, allowing the bottom hole assembly 1220 to transfer the added weight to the drill bit 1226, and in turn, to assist the drill bit 1226 in penetrating the surface 105 and subsurface formations 110.

Thus, it may be seen that in some embodiments, the systems 1100, 1200 may include a drill collar 1222, a downhole tool 1224, and/or a wireline logging tool body 1170 to house one or more receivers 102, similar to or identical to the receivers 102 described above and illustrated in FIG. 1. Components of the system 1000 in FIG. 10 may also be housed by the tool 1224 or the tool body 1170.

Thus, for the purposes of this document, the term housing may include any one or more of a drill collar 1222, a downhole tool 1224, or a wireline logging tool body 1170 (all having an outer wall, to enclose or attach to magnetometers, sensors, fluid sampling devices, pressure measurement devices, transmitters, receivers, acquisition and processing logic, and data acquisition systems). The tool 1224 may comprise a downhole tool, such as an LWD tool or MWD tool. The wireline tool body 1170 may comprise a wireline logging tool, including a probe or sonde, for example, coupled to a logging cable 1114. Many embodiments may thus be realized.

Thus, a system 1100, 1200 may comprise a downhole tool body, such as a wireline logging tool body 1170 or a downhole tool 1224 (e.g., an LWD or MWD tool body), and one or more receivers 102 attached to the tool body, the receivers 102 to be operated as described previously.

Any of the above components, for example the receivers 102, processors 1020, etc., may all be characterized as modules herein. Such modules may include hardware circuitry, and/or a processor and/or memory circuits, software program modules and objects, and/or firmware, and combinations thereof, as desired by the architect of the systems 1000, 1100, 1200 and as appropriate for particular implementations of various embodiments. For example, in some embodiments, such modules may be included in an apparatus and/or system operation simulation package, such as a software electrical signal simulation package, a power usage and distribution simulation package, a power/heat dissipation simulation package, and/or a combination of software and hardware used to simulate the operation of various potential embodiments.

It should also be understood that the apparatus and systems of various embodiments can be used in applications other than for logging operations, and thus, various embodiments are not to be so limited. The illustrations of systems 1000, 1100, 1200 are intended to provide a general understanding of the structure of various embodiments, and they are not intended to serve as a complete description of all the elements and features of apparatus and systems that might make use of the structures described herein.

The above-described embodiments use global optimization schemes that allow oil and gas producers to increase and enhance oil and gas production by robustly and accurately estimating transversely isotropic media parameters from direct P-wave arrivals when geophones and sources are in a walkaway VSP configuration. For example, the systems 1000, 1100, and 1200 can generate profiles for anisotropic parameters such as those shown in FIGS. 13-15.

FIG. 13 illustrates best inversion solution 1302 and true solution 1304 velocity profiles to illustrate accuracy of some embodiments. For example, it can be seen that the best inversion solution 1302, achievable utilizing methods as described earlier herein, are very close to the true solution 1304. A best inversion solution 1302 can include, for example, a solution in one of the child populations 808 or parent population 702 as described earlier herein with reference to FIGS. 3-9. Search boundaries 1306 are also illustrated. The processor 1020 can generate or access these search boundaries according to operation 506 (FIG. 5), although embodiments are not limited to any particular method of defining search boundaries.

Similarly, FIG. 14 illustrates best solution 1402 and true solution 1404 epsilon profiles, to illustrate accuracy of some embodiments. Search boundaries 1406 are also illustrated. FIG. 15 illustrates best solution 1502 and true solution 1504 delta profiles to illustrate accuracy of some embodiments. Search boundaries 1506 are also illustrated.

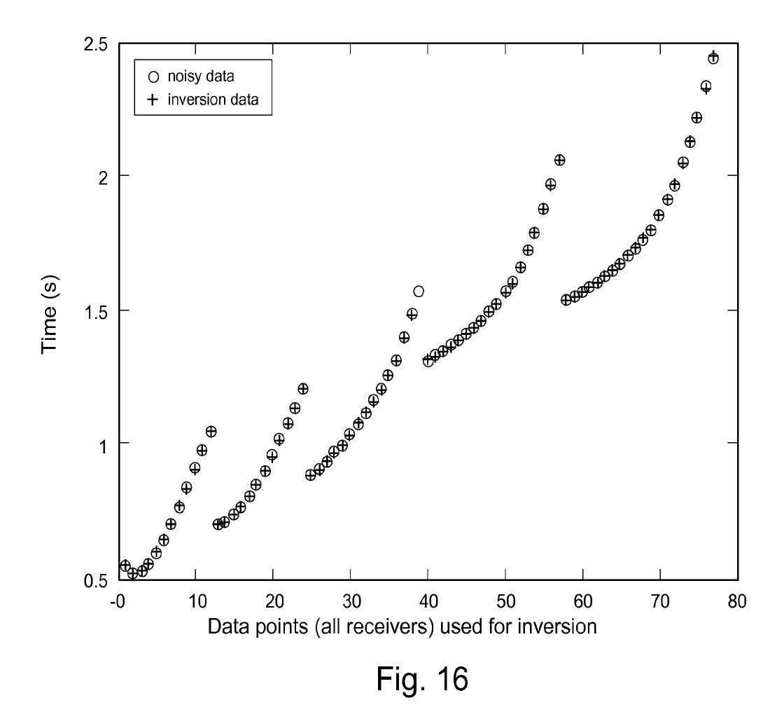

FIG. 16 illustrates noisy synthetic data (crosses in FIG. 16) and data generated in accordance with some embodiments (circles in FIG. 16) to illustrate the accuracy of some embodiments. FIG. 16 illustrates that the inversion methodology in accordance with various embodiments converges to the correct solution accurately in the presence of noise in the data and in the presence of a complicated configuration of sources and receivers in a laterally heterogeneous subsurface with anisotropic effects.

Further examples of apparatuses, methods, a means for performing acts, systems or devices include, but are not limited to:

Example 1 is a method comprising operations wherein any of the apparatuses, devices, systems, or portions thereof can include means for performing the method of Example 1, and wherein the method of Example 1 comprises generating a parent population, wherein each member of the parent population includes a set of model parameters describing a layer model of the geological formation; executing a perturbation algorithm to generate subsequent child populations, from the parent population, until a termination criterion is met; providing a plurality of solutions based on at least one member of the parent population and on at least one member of each child population; and controlling a drilling operation based on a revised layer model that has been generated based on a selected one of the plurality of solutions.

Example 2 includes the subject matter of Example 1, wherein the perturbation algorithm optionally includes a differential evolution (DE) algorithm.

Example 3 includes the subject matter of any of Examples 1-2, wherein the set of model parameters optionally includes a propagation velocity Vₚ₀ , of acoustic waves along a symmetry axis within each respective layer of the geological formation, and anisotropic parameters along the symmetry axis of each respective layer of the geological formation and wherein each solution in each of the parent population and child populations includes of values for the model parameters for each layer of the layer model.

Example 4 includes the subject matter of any of Examples 1-3, and optionally further comprising providing a step size for generating a DE mutant solution for each child population member generated by the DE algorithm; and perturbing the step size for each model parameter in each mutant solution calculation in each subsequent child population.

Example 5 includes the subject matter of Example 4, wherein each subsequent child population is optionally generated by selecting population members, based on objective function values, from a sequentially previous child population and a mutant population, and wherein the termination criterion includes at least one of a value for the number of child populations that have been generated and a threshold value corresponding to the objective function.

Example 6 includes the subject matter of Example 4, and further optionally comprising generating trial solutions from the mutant population and based on a crossover rate.

Example 7 includes the subject matter of any of Examples 5-6, and further optionally comprising applying a smoothing algorithm by adding a penalty term to objective function values for which a corresponding model parameter value has met or exceeded a boundary value.

Example 8 includes the subject matter of Example 5, and further optionally comprising generating objective function values for each subsequent child population; and providing a display of objective function values, the parent population, and at least one child population.

Example 9 includes the subject matter of any one of Examples 1-8, and further optionally comprising accessing search boundaries that limit values for the set of model parameters; and providing the search boundaries as inputs to the DE algorithm.

Example 10 includes the subject matter of Example 9, wherein the search boundaries are optionally based on surface seismic measurements of the set of model parameters.

Example 11 includes the subject matter of any of Examples 1-10, and further optionally comprising generating an initial layer model based on surface seismic measurements; and generating a revised layer model by minimizing a mismatch between observed P-wave first arrival travel times and calculated P-wave travel times that have been calculated using an anisotropic ray tracing (ART) algorithm.

Example 12 is a system, which can include means of performing any of Examples 1-11 comprising a seismic source for emitting a seismic wave into a geological formation; a seismic receiver configured to detect the seismic wave and to generate a seismic signal; and a processor to receive seismic signals generated by the seismic receiver and to generate a parent population, wherein each member of the parent population includes a set of model parameters describing a layer model of the geological formation; execute a perturbation algorithm to generate subsequent child populations, from the parent population, until a termination criterion is met; provide a plurality of solutions based on at least one member of the parent population and on at least one member of each child population; and control a drilling operation based on a revised layer model that has been generated based on a selected solution of the plurality of solutions.

Example 13 includes the subject matter of Example 12, and optionally further comprising memory to store data representative of a seismic survey collected over the geological formation; and data representative of the layer model.

Example 14 includes the subject matter of any of Examples 12-13, and further optionally comprising a telemetry transmitter to provide data representative of the seismic wave to the processor.

Example 15 includes the subject matter of any of Examples 12-14, and further optionally comprising a display to display the plurality of solutions.

Example 16 includes computer-readable medium including instructions that, when executed on a machine, cause the machine to perform any of the functions of Examples 1-15, including generating a parent population, wherein each member of the parent population includes a set of model parameters describing a layer model of the geological formation; executing a perturbation algorithm to generate subsequent child populations, from the parent population, until a termination criterion is met; providing a plurality of solutions based on at least one member of the parent population and on at least one member of each child population; and controlling a drilling operation based on a revised layer model that has been generated based on a selected solution of the plurality of solutions.

Example 17 includes the subject matter of Example 16, wherein the perturbation algorithm optionally includes a DE algorithm.

Example 18 includes the subject matter of any of Examples 16-17, wherein the model parameters optionally include a propagation velocity Vₚ₀ of acoustic waves along a symmetry axis within each respective layer of the geological formation, and anisotropic parameters along the symmetry axis of each respective layer of the geological formation and wherein each solution in each of the parent population and child populations optionally includes a set of values for the model parameters for each layer of the layer model.

Example 19 includes the subject matter of any of Examples 17-18, and optionally further including providing a step size for generating a DE mutant solution for each child population member generated by the DE algorithm; and perturbing the step size for each model parameter in each mutant solution calculation in each subsequent child population.

Example 20 includes the subject matter of Example 19 and further optionally comprising generating each subsequent child population by selecting population members, based on objective function values, from a sequentially previous child population and a trial population, and wherein the termination criterion includes at least one of a value for the number of child populations that have been generated and a threshold value corresponding to the objective function.

Upon reading and comprehending the content of this disclosure, one of ordinary skill in the art will understand the manner in which a software program can be launched from a computer-readable medium in a computer-based system to execute the functions defined in the software program, to perform the methods described herein. One of ordinary skill in the art will further understand the various programming languages that may be employed to create one or more software programs designed to implement and perform the methods disclosed herein. For example, the programs may be structured in an object-orientated format using an object-oriented language such as Java or C#. In another example, the programs can be structured in a procedure-orientated format using a procedural language, such as assembly or C. The software components may communicate using any of a number of mechanisms well known to those of ordinary skill in the art, such as application program interfaces or interprocess communication techniques, including remote procedure calls. The teachings of various embodiments are not limited to any particular programming language or environment. Thus, other embodiments may be realized. Furthermore, software components can communicate with databases, for example relational databases, using SQL stored procedures, etc.

Although specific embodiments have been illustrated and described herein, it will be appreciated by those of ordinary skill in the art that any arrangement that is calculated to achieve the same purpose may be substituted for the specific embodiments shown. Various embodiments use permutations or combinations of embodiments described herein. It is to be understood that the above description is intended to be illustrative, and not restrictive, and that the phraseology or terminology employed herein is for the purpose of description. Combinations of the above embodiments and other embodiments will be apparent to those of ordinary skill in the art upon studying the above description.

What is claimed is:

1. A method of estimating parameters of a geological formation, the method comprising:
generating a parent population, wherein each member of the parent population includes a set of model parameters describing a layer model of the geological formation;
executing a perturbation algorithm to generate subsequent child populations, from the parent population, until a termination criterion is met;
providing a plurality of solutions based on at least one member of the parent population and on at least one member of each child population; and
controlling a drilling operation based on a revised layer model that has been generated based on a selected one of the plurality of solutions.

2. The method of claim 1, wherein the perturbation algorithm includes a differential evolution (DE) algorithm.

3. The method of claim 2, wherein the set of model parameters include a propagation velocity Vₚ₀ of acoustic waves along a symmetry axis within each respective layer of the geological formation, and anisotropic parameters along the symmetry axis of each respective layer of the geological formation and wherein each solution in each of the parent population and child populations includes of values for the model parameters for each layer of the layer model.

4. The method of claim 2, further comprising:
providing a step size for generating a DE mutant solution for each child population member generated by the DE algorithm; and
perturbing the step size for each model parameter in each mutant solution calculation in each subsequent child population.

5. The method of claim 4, wherein each subsequent child population is generated by selecting population members, based on objective function values, from a sequentially previous child population and a mutant population, and wherein the termination criterion includes at least one of a value for the number of child populations that have been generated and a threshold value corresponding to the objective function.

6. The method of claim 5, further comprising generating trial solutions from the mutant population and based on a crossover rate.

7. The method of claim 6, further comprising:
applying a smoothing algorithm by adding a penalty term to objective function values for which a corresponding model parameter value has met or exceeded a boundary value.

8. The method of claim 5, further comprising:
generating objective function values for each subsequent child population; and
providing a display of objective function values, the parent population, and at least one child population.

9. The method of claim 1, further comprising:
accessing search boundaries that limit values for the set of model parameters; and
providing the search boundaries as inputs to the DE algorithm.

10. The method of claim 9, wherein the search boundaries are based on surface seismic measurements of the set of model parameters.

11. The method of claim 1, further comprising:
generating an initial layer model based on surface seismic measurements; and
generating a revised layer model by minimizing a mismatch between observed P-wave first arrival travel times and calculated P-wave travel times that have been calculated using an anisotropic ray tracing (ART) algorithm.

12. A system, comprising:
a seismic source for emitting a seismic wave into a geological formation;
a seismic receiver configured to detect the seismic wave and to generate a seismic signal; and
a processor to receive seismic signals generated by the seismic receiver and to
generate a parent population, wherein each member of the parent population includes a set of model parameters describing a layer model of the geological formation;
execute a perturbation algorithm to generate subsequent child populations, from the parent population, until a termination criterion is met;
provide a plurality of solutions based on at least one member of the parent population and on at least one member of each child population; and
control a drilling operation based on a revised layer model that has been generated based on a selected solution of the plurality of solutions.

13. The system of claim 12, further comprising:
memory to store
data representative of a seismic survey collected over the geological formation; and
data representative of the layer model.

14. The system of claim 12, further comprising:
a telemetry transmitter to provide data representative of the seismic wave to the processor.

15. The system according to claim 14, further comprising:
a display to display the plurality of solutions.

16. A non-transitory machine-readable storage device including instructions that, when executed on a machine, cause the machine to perform operations comprising:
generating a parent population, wherein each member of the parent population includes a set of model parameters describing a layer model of the geological formation;
executing a perturbation algorithm to generate subsequent child populations, from the parent population, until a termination criterion is met;
providing a plurality of solutions based on at least one member of the parent population and on at least one member of each child population; and
controlling a drilling operation based on a revised layer model that has been generated based on a selected solution of the plurality of solutions.

17. The machine-readable storage device of claim 16, wherein the perturbation algorithm includes a differential evolution (DE) algorithm.

18. The machine-readable storage device of claim 17, wherein the model parameters include a propagation velocity Vₚ₀ of acoustic waves along a symmetry axis within each respective layer of the geological formation, and anisotropic parameters along the symmetry axis of each respective layer of the geological formation and wherein each solution in each of the parent population and child populations includes a set of values for the model parameters for each layer of the layer model.

19. The machine-readable storage device of claim 17, wherein the instructions further cause the machine to perform operations comprising:
providing a step size for generating a DE mutant solution for each child population member generated by the DE algorithm; and
perturbing the step size for each model parameter in each mutant solution calculation in each subsequent child population.

20. The machine-readable storage device of claim 19, wherein the instructions further cause the machine to perform operations comprising:
generating each subsequent child population by selecting population members, based on objective function values, from a sequentially previous child population and a trial population, and wherein the termination criterion includes at least one of a value for the number of child populations that have been generated and a threshold value corresponding to the objective function.
